(19) United States
(12) Patent Application Publication
(10) Pub. No.: US 2025/0143497 A1
(43) Pub. Date: May 8, 2025

(54) CARPET PILE SEAM ROLLER

(71) Applicant: Q.E.P. Co. Inc., Boca Raton, FL (US)

(72) Inventors: Bradley Scott MILLER, Boca Raton, FL (US); Joseph DEGUGLIMO, Boca Raton, FL (US)

(73) Assignee: Q.E.P. Co. Inc., Boca Raton, FL (US)

(21) Appl. No.: 18/500,206

(22) Filed: Nov. 2, 2023

(51) Int. Cl. A47G 27/04; B25G 1/10; D06H 5/00

(52) U.S. Cl. CPC A47G 27/0487; B25G 1/102; D06H 5/00; D10B 2503/04

(57) ABSTRACT

A carpet pile seam roller includes handle and a roller, the roller attached to the handle. The handle includes a first recess adapted to receive at least a first portion of a first hand of a user, and a second recess adapted to receive at least a first portion of a second hand of a user.

### BACKGROUND

The subject matter discussed in this background section should not be assumed to be prior art merely as a result of its mention in this background section. Similarly, a problem mentioned in this background section or associated with the subject matter of this background section should not be assumed to have been previously recognized in the prior art. The subject matter in this background section merely represents different approaches, which in and of themselves may also be inventions.

This invention relates to a carpet pile seam roller. It relates particularly to a carpet pile seam roller which is effective to draw two adjacent sections of carpet together in an adhesive seam operation during both pushing and pulling movement of the seam roller forward and backward along the seam.

Carpet pile refers to the loops of fabric within a carpet. Low pile carpets have tighter loops of fabric and shorter fibers when compared to deep pile or high pile carpets. The pile or fabric is attached to the carpet backing which is traditionally made of synthetic jute or polypropylene woven together in a tight grid pattern.

Many carpet installations are done using a hot melt carpet seam tape in a seam operation. One example of a heat melt seam roller is illustrated and described in U.S. Pat. No. 4,439,904 to Hoopengardner et al issued Apr. 3, 1984, the entirety of which is hereby incorporated by reference.

Many other carpet installations are done using a carpet seam tape which may be a double sided adhesive. The tape may be first adhered to the floor or subfloor, the edge of the first piece of carpet is placed on the tape, and then the edge of a second piece of carpet is placed on the tape adjacent the edge of the first piece of carpet, i.e., the carpet edges are placed side by side. Then, a carpet pile seam roller is rolled back and forth along the seam to press the edges of the carpet sections firmly on the adhesive tape. This results in strong adhesion between the tape and the underside of the carpet thus keeping the carpet edges together. The seam roller handle is traditionally held in one hand and the carpet installer applies a downward or vertical force, pushing the carpet onto the backing, as well as a horizontal or rolling force along the length of the carpet seam.

The use of one hand on the roller by the installer leads to fatigue and, in addition, limits the amount of downward force that is applied to push the carpet tile into contact with the adhesive seam tape thus limiting the degree of adhesion between the carpet and the adhesive tape.

### SUMMARY

The present invention is directed to a new and improved seam roller that allows the carpet installer to apply pressure with both hands simultaneously, and in both the downward (sealing or vertical) and rolling (horizontal and back-and-forth) directions. The present invention thus provides for greater adhesion between the sealing tape and the underside or backing of the carpet and results in reduced fatigue of the installer.

### BRIEF DESCRIPTION OF THE FIGURES

The features, benefits and advantages of the present invention will become more apparent upon reading the following detailed description of the invention taken in conjunction with the drawings.

In the following drawings like reference numbers are used to refer to like elements. Although the following figures may depict various examples of the invention, the invention is not limited to the examples depicted in the figures.

FIG. 1 is a top plan view of a carpet pile seam roller (handle and roller assembly) constructed in accordance with one embodiment of the invention;

FIG. 2 is a side elevation view of the carpet pile seam roller of FIG. 1;

FIG. 3 is a perspective view of the carpet pile seam roller when viewed generally from the front left side; and

FIG. 4 is a perspective view of the carpet pile seam roller when viewed generally from the rear left side.

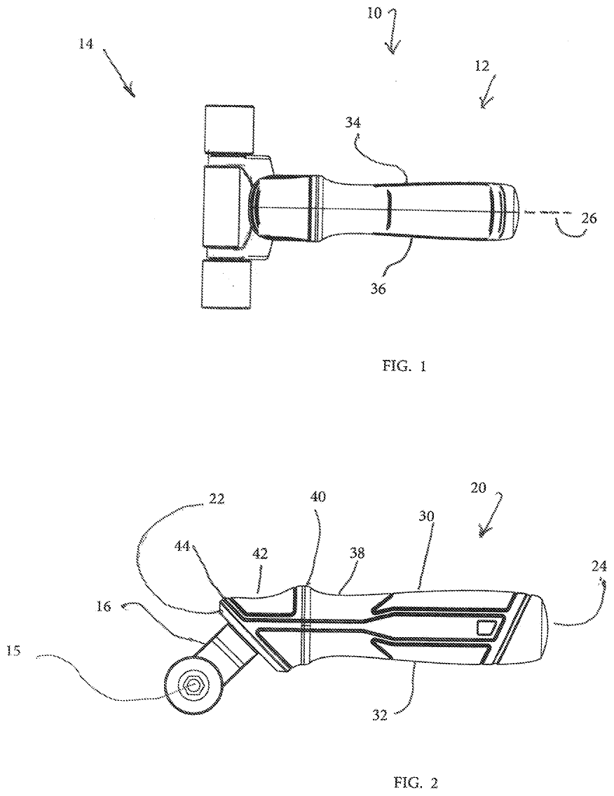

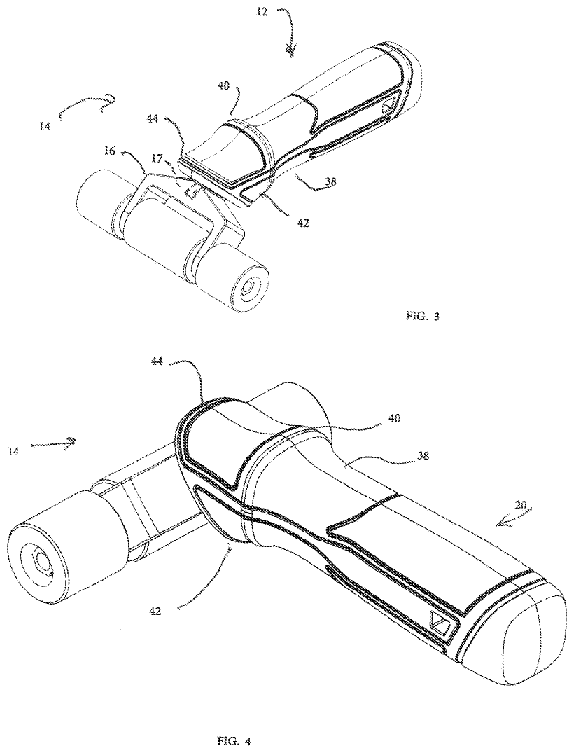

### DETAILED DESCRIPTION

Although various embodiments of the invention may have been motivated by various deficiencies with the prior art and which may be discussed or alluded to in one or more places in the specification, the embodiments of the invention as illustrated and/or described do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Relative terms such as but not limited to front, rear, top, bottom, left and right, center and middle, as well as references to various views, are used for illustrative non-limiting purposes. Similarly, terms that describe shapes are used for illustrative non-limiting purposes.

A carpet pile seam roller and handle assembly 10 includes an elongated handle 12 to which a roller 14, mounted for rotation about an axle 15, is attached to the handle through a yoke 16. The yoke may be generally “Y” shaped in a top plan view and the axle is mounted in the ends of the yoke. The central portion of the yoke is attached to the handle with a fastener 17. A yoke and roller combination per se is old as are the attachment of a yoke to the handle of a roller assembly and the attachment of the roller to the yoke.

The roller 14 includes an elongated body 20 having a first end 22 and a second end 24. The body is of generally circular cross section when viewed from the second end 24. A longitudinal axis 26 extends from the second end 24 through the body 20. The roller handle is preferably formed of a hard rubber and the circumference is such that it may be conveniently grasped by the hand of the user/carpet installer.

The body 20 includes opposed, spaced apart top and bottom portions 30, 32 and opposed, spaced apart side portions 34, 36.

The longitudinal axis 26 extends generally parallel to the side portions 34, 36. The first end 22 of the body is formed at an angle to the longitudinal axis with the bottom of the first end being closer to the second end than the top of the first end. The second end 24 of the body is preferably formed perpendicular to the axis 26.

The handle 12 includes a first curved or concave portion 38 relative to the axis 26 and the body 20. The concave surface or curved portion 38 preferably extends around the entire circumference of the handle 12 and terminates in a first upwardly extending projection 40. The first projection 40 is offset inwardly from the first end 22 of the handle body and is preferably of larger diameter than the handle body 20. The curved portion 38 is configured such that when the handle body is gripped by the hand of the user, the thumb of the user may conveniently be placed on the top of the body, resting in the curved portion 38 and in contact with the first projection 40. At the same time, the first finger of the hand of the user may conveniently be placed on the bottom of the body and also resting in the curved portion 38 and in contact with the first projection 40. Thus, the first projection may limit or resist axial movement of the hand of the user or carpet installer.

The handle 12 includes a second curved or concave portion 42 relative to the axis 26 and the body 20. This second concave surface or curved portion 42 preferably extends around the entire circumference of the handle 12 and terminate in a second upwardly extending projection 44. Because of the angle of first end 22 relative to the axis 26, the curved portion 42 has a greater length, in an axial direction, at the top 30 of the handle, compared to the axial length of the curved portion 42 at the bottom 32 of the handle.

The second projection 44 is preferably at the first end 22 of the handle body. The curved portion 42 is configured such that when the user grips the handle body with one hand, the second hand of the user may conveniently be placed therein with the projection limiting or resisting any movement of the second hand of the user. The thumb, or the heel of the hand, or other parts of the second hand of the user, may be placed in the second curved or concave portion 42, and in contact with the second projection 44. Or, if desired, the user may engage the circumference of the second curved portion 42 with one hand while engaging the circumference of first curved portion 38 with the other hand.

The use of two hands concurrently, as just described, increases both the downward and rolling forces while reducing fatigue of the user/carpet installer.

In use or operation of the roller, an adhesive tape (preferably double-sided) is placed on the floor or sub-floor and one edge of the carpet backing of a first piece of carpet is placed on the tape. The edge of a second piece of carpet is placed adjacent the edge of the first piece of carpet again with the carpet backing placed on the tape. The seam roller is then applied to the seam, i.e., the region where the edges of the two pieces of carpet tile are in contact. The user of the seam roller grips the handle body 20 with a first hand with a portion of the first hand adjacent to the first projection 40. The user of the seam roller grips the handle body with a second hand with a portion of the second hand adjacent to the second projection.

The user then pushes and pulls the seam roller back and forth in a generally horizontal plane while simultaneously pushing the seam roller downwardly, with both hands, toward the carpet. The resulting downward force pushes the carpet backing against the adhesive and results in an improved adhesive bonding between the adhesive tape and the carpet backing. To facilitate the application of downward force during carpet seaming while not impeding the horizontal, bidirectional rolling, first end 22 of the handle body is formed at an angle relative to the axis 26 with the bottom 32 of the handle being closer to the second end 24 than the second projection 44. The second end 24 of the body 20 is preferably generally perpendicular to the axis.

While we have illustrated and described the preferred embodiments of our invention, it is to be understood by those skilled in the art that various changes may be made and equivalents may be substituted for elements thereof without departing from the true spirit and scope of the invention. Our invention, therefore, should be limited only by the following claims and their equivalents.

We claim:

1. A handle for a carpet seam roller,
the handle having a first end and a second end, the second end being spaced apart longitudinally from the first end and having an elongated axis extending from the second end toward the first end;
the handle having a top and a bottom spaced apart from each other, the top and bottom each extending from the first end to the second end;
the handle having a first side and a second side spaced apart from each other;
the handle including a first recess adapted to receive at least a first portion of a first hand of a user; and
the handle including a second recess adapted to receive at least a first portion of a second hand of a user.

2. The handle of claim 1, wherein the first recess extends circumferentially around the handle.

3. The handle of claim 1, wherein the second recess extends circumferentially around the handle.

4. The handle of claim 3, wherein the first recess extends circumferentially around the handle.

5. The handle of claim 1, wherein the top and bottom extend generally parallel to said elongated axis.

6. The handle of claim 1, wherein the first side and second side extend generally parallel to said elongated axis.

7. The handle of claim 1, wherein the first side and second side extend generally from the first end to the second end.

8. The handle of claim 1, wherein the first recess terminates in a first projection offset from said first end toward said second end.

9. The handle of claim 1, wherein the handle body is of generally circular cross section.

10. The handle of claim 1, wherein the second recess terminates in a second projection adjacent the first end.

11. The handle of claim 1, wherein said first end is formed at an angle transverse to said elongated axis.

12. The handle of claim 1, wherein said second end is generally perpendicular to said axis.

13. A carpet pile seam roller comprising:
a yoke,
a roller mounted for rotation on an axle, the axle attached to said yoke,
a handle according to claim 1, and
said yoke attached to said first end of said handle.
